(19) United States
(12) Patent Application Publication
(10) Pub. No.: US 2006/0280863 A1
(43) Pub. Date: Dec. 14, 2006

(54) Method and application equipment for the powder painting of a manufatured article

(75) Inventor: Silvio Maria Trevisan, Verona (IT)

Correspondence Address: THE FIRM OF KARL F ROSS, 5676 RIVERDALE AVENUE, PO BOX 900, RIVERDALE (BRONX), NY, 10471-0900, US

(73) Assignee: TREVISAN COMETAL S.P.A., Verona (IT)

(21) Appl. No.: 10/555,864

(22) PCT Filed: Jun. 23, 2003
(86) PCT No.: PCT/EP03/06598

§ 371 Date: Nov. 4, 2005

(30) Foreign Application Priority Data
May 7, 2003 (IT) MI2003 A 000918

(51) Int. Cl. B05D 1/12; B05C 19/00

(52) U.S. Cl. 427/180; 118/308; 118/66

(57) ABSTRACT

The method used for powder painting a manufactured article comprises the application of a first layer of powder paint, the fixing of the first paint layer, the application of a second layer of powder paint in a colour, tone and/or properties that are different from those of the first layer, the final baking of the first and second layers of paint, the rolling and/or brushing of the manufactured article to confer the required decoration thereon, and it is obtained by the continuous forward movement of at least one manufactured article and by performing by painting means and by rolling and/or brushing means respectively, during the rolling and/or brushing steps, a corresponding closed cyclic passage comprising the movement of the manufactured article for at least a first section during which it is subject to relative transfer between the painting means and the respective rolling and/or brushing means and the manufactured article.

The present invention relates to a method and equipment for the application of powder painting on a manufactured article. Powder painting is currently used very widely in the field of surface decoration to imitate a wood finish on metal sections normally destined for manufacturing window and door frames.

The painting method traditionally used comprises a first step for the application of a first layer of base coat, followed by a step for fixing said layer by means of partial paint polymerisation, a successive step comprising the application of a second decorative layer of paint, and a final step comprising the baking method to complete the polymerisation of the two layers of paint.

Traditional painting methods present certain drawbacks that restrict wide scale industrial application, above all in the application of the decorative layer that often requires control by an experienced and expert person.

Because of the need for qualified personnel, this traditional painting method results as not being very productive.

Other painting methods using automated systems are well-known, but the final results are not satisfactory because the reproduction of the required decorative appearance is not acceptable.

Therefore the technical object of the present invention is to realise a powder painting method and application equipment for manufactured articles that will eliminate the technical drawbacks encountered in prior art.

In the context of this technical task, one object of the invention is to realise a completely automated method and application equipment for powder painting.

A further object of the invention is to realise a powder painting method and application equipment able to provide an imitation wood finish that reproduces the required decorative pattern perfectly on the manufactured article.

Yet another object of the present finding is to provide a powder painting method and application equipment that will optimise productive cyclic times eliminating idle time.

Last but not least object of the invention is to realise a powder painting method and application equipment that are economical, efficient, and easy to use.

The technical task as well as these and other objects according to the present invention are achieved realising a powder painting method applied to at least one manufactured article comprising the application of a first layer of powder paint, the fixing of the first paint layer, the application of a second layer of powder paint in a colour, tone and/or properties that are different from those of the first layer, the final baking of the first and at least second layers of paint, the rolling and/or brushing of the manufactured article to confer the required decoration thereon, characterised in that said method is obtained through the continuous forward movement of said at least one article, and by passing at least first painting means during the painting step, and first rolling and/or brushing means respectively, during the rolling and/or brushing steps, in a corresponding closed cyclic passage comprising the travel of the manufactured article for at least a first following up section of said at least one manufactured article during which it is subject to relative transfer between said at least first painting means and rolling and/or brushing means respectively and said at least one manufactured article.

Other characteristics of the present invention are explained in the following claims.

Further characteristics and advantages of the invention will be more evident in the description of a preferred but not limiting embodiment of the powder painting method and application equipment according to the finding illustrated as an example but in no way limitative, in the appended drawings wherein:

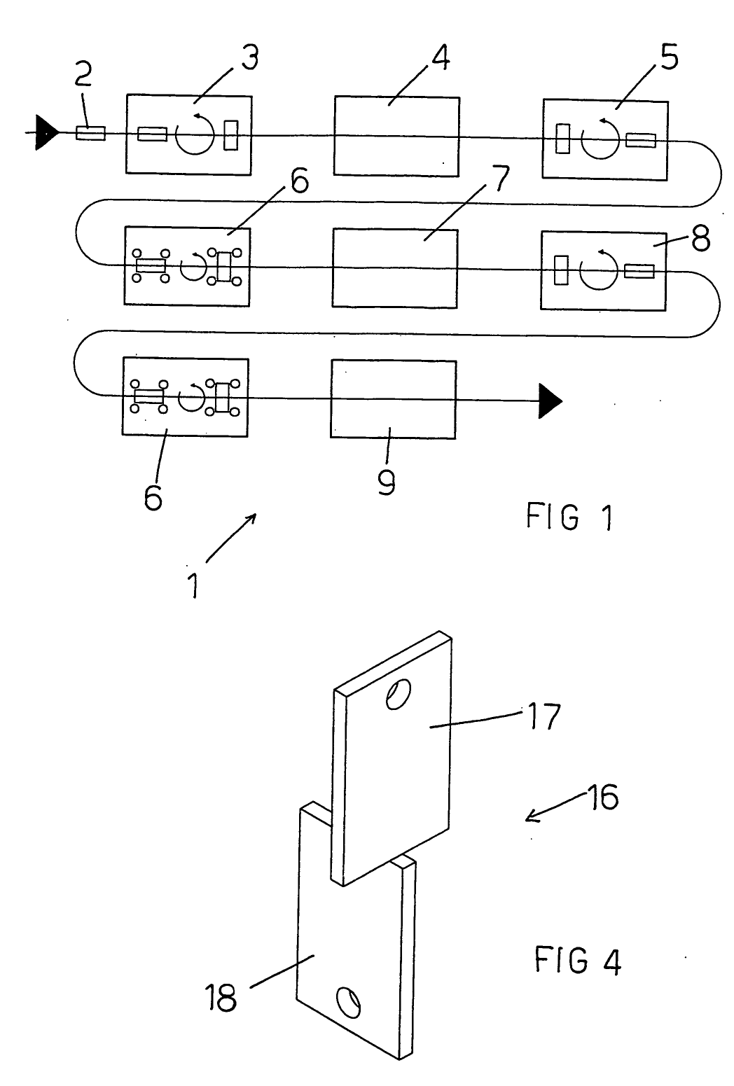

FIG. 1 shows a schematic view of the various powder painting method steps according to the present finding;

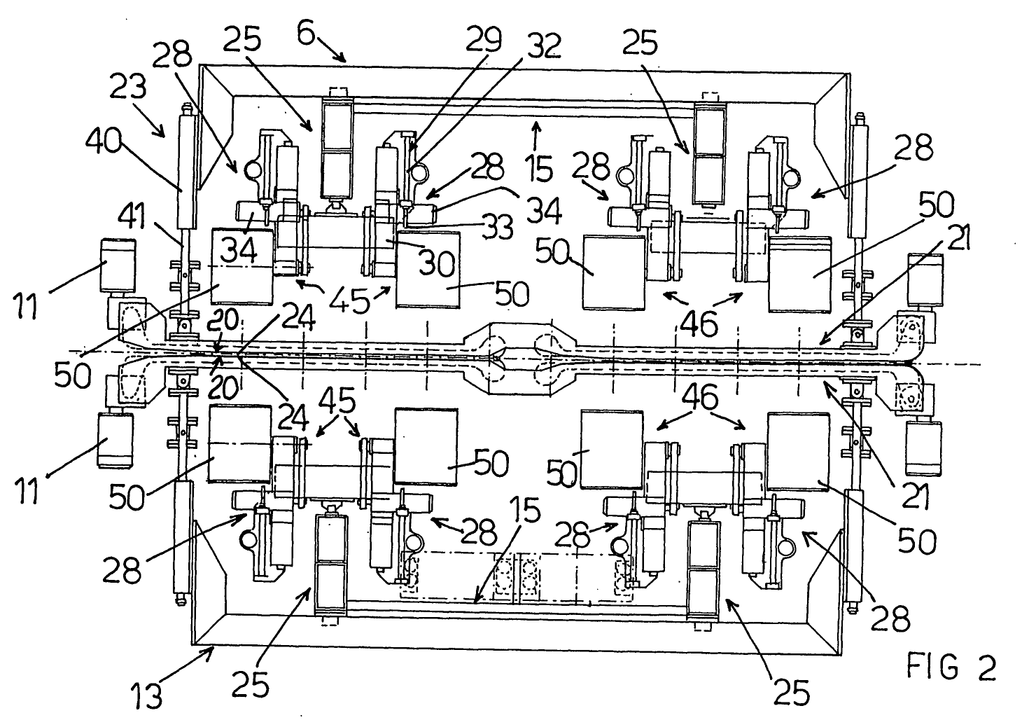

FIG. 2 shows a plane view of the rolling and/or brushing centre of the present invention in idle position;

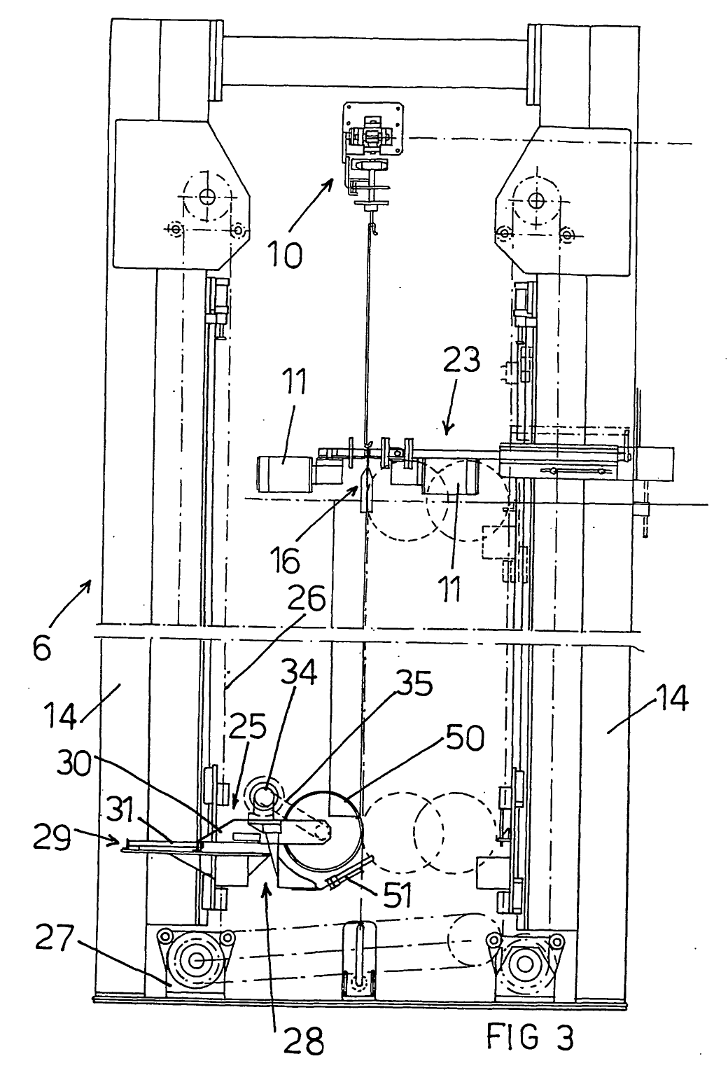

FIG. 3 shows a side view in elevation of the rolling and brushing centre shown in FIG. 2 demonstrating a single left hand side roller/brush unit only in working position, where the dotted lines show the working and idle positions of the right hand side roller/brush unit;

FIG. 4 shows an enlargement of the support element of an envisaged manufactured article applied to an overhead transport conveyor according to the present finding.

In reference to FIG. 1, an automated powder painting equipment for one or more manufactured articles 2 is shown, identified throughout by the reference numeral 1.

The method carried out by the equipment 1 is preferably developed in sequence through a first painting centre 3, in which a first base coat is applied to each manufactured article 2, a fixing station 4 comprising an oven (not illustrated) for fixing or partial polymerisation of the base coat, a second painting centre 5 where each manufactured article 2 is coated with a second layer of paint with a colour, tone and/or properties different from the first base coat, a rolling and/or brushing equipment 6, used exclusively for brushing operations to confer a uniform variegated aspect, a second fixing station for fixing the second coat of paint, at least a third painting centre 8 where each article 9 is coated with a third layer of paint, a second brushing and/or rolling equipment 6 used exclusively for brushing operations to provide each article with the required decorative finish, and a final baking station 9 adapted to complete the polymerisation process of the three paint layers applied to each manufactured article 2.

In reference to the other remaining figures, each manufactured article 2 is transported by an overhead conveyor line 10 controlled by driving means, such as a motor 11, adapted to transport each manufactured article 2 in continuous mode through the successive steps of the painting process.

The illustrated equipment 1 is vertical type, but the inventive concept of the present finding can be just as easily applied to horizontal painting equipment.

In the equipment 1 each manufactured article is therefore suspended vertically and travels in a horizontal direction.

Each manufactured article 2 is typically a metal section with four sides in the form of 2 pairs of sides opposite each other, therefore the treatment in each painting centre and each roller and/or brusher unit requires two separate positions between which a rotation unit is positioned (not shown) adapted to rotate each manufactured article 2 by 90° so that one pair of opposite sides of each article 2 is treated at the same time in the first position, while the other pair of opposite sides is treated at the same time in the second position.

Advantageously, both the painting means (in the form of a spray gun for example, not shown) and the rolling and/or brushing means on the roller and/or brush equipment are supported by a corresponding mobile support unit adapted to move said means along the closed cyclic passage during use.

This closed cyclic passage comprises at least one section of the manufactured article 2 travel path which develops along a direction on a slope compared to the movement direction of manufactured article 2, and during which the painting means or brushing and/or roller means is subject to position change in relation to article 2.

In particular, in order to apply each layer of paint, the painting means follows a first section along the corresponding cyclic passage, this section being on a slope compared to the article 2 movement direction, a first return section in the direction parallel to the article 2 movement direction, a second section on a slope compared to the article 2 movement direction, and a second return section parallel to the article 2 movement direction.

Therefore the painting means follows an “8” shaped path composed of two forward movement lines and two return lines.

Measuring means (not shown) is positioned corresponding to at least the second painting centre, and in particular, both the second and the third painting centres. Said measuring means is the same size as the manufactured articles 2 connected to a control means adapted to enable the delivery of a precise amount of paint according to the measurement performed and a dedicated formula that decides the amount of paint necessary for the final required finish effect.

In particular, the measuring means includes a first photocell that detects a first measurement related to the size of one of the pairs of opposite sides of article 2 and a second photocell that detects the second measurement related to the other pair of opposite sides of article 2.

This double measurement can be carried out by rotating the article 2 by 90° between one measuring operation and the other.

The result of the double measurement is transmitted to said control means, in turn connected to data storage means containing all the information in relation to the amount of paint to be used according to the calculated measurements.

In particular data storage means contains a first series of values concerning the amount of paint to be used and a second series of value ranges equal to the sum of the first and second measurement.

Each value of the first series is associated with a value range of the second series, so that after receiving the values of the first and second measurements, the control means checks at which value range the sum of the first and second measurement belong, and refer back to the corresponding value of the amount of paint to be used.

In order to create the corresponding cyclic passage, the mobile support unit (not shown) of the painting means moves preferably along a fixed guide comprising a first and a second portion of guide on a slope compared to the article 2 movement direction, and a third and a fourth portion parallel to the article 2 movement direction.

The same cyclic passage can be created in an alternative manner wherein the mobile support unit of the painting means can move on a guide set at right angles, and in this particular case, set vertically in relation to the manufactured article 2 movement direction, and is mounted on another support that moves in a direction parallel to the manufactured article 2 movement direction.

Below is the description of the roller and/or brushing equipment 6.

This is composed of a frame 13 having two opposite rows of uprights 14, adapted to limit the work area along which the article(s) 2 travel on the centre line transported by the overhead conveyor 10.

The equipment 6 includes at least a first mobile support unit for at least the first roller and/or brushing means, for example a first roller 50/brush 51 unit. Preferably, the side surface of roller 50 will be coated with a layer of elastically deformable material, the work face being composed of hollows and peaks especially processed on the surface according to the graphic result required on the manufactured article 2 finish.

Preferably, the equipment 6 has at least a second roller and/or brushing means, for example a second roller/brush unit for simultaneous rolling and/or brushing of the two manufactured articles.

In particular, the equipment 6 has a first set 45 and a second set 46 of two pairs of roller/brush units opposite each other in relation to the centre line of the work area.

The article 2 rotation unit is positioned between the first and second sets of roller/brush units 45 and 46.

The adjacent roller/brush units of the first and second sets 45 and 46 respectively, are supported by a single corresponding mobile support unit 15 adapted to guide them along the closed cyclic passage comprising a single portion of the manufactured article 2 passage during which the relative position change between roller/brush unit and article 2 is set.

The section develops along a slope compared to the article 2 movement direction.

Advantageously, the uprights 14 are set on a slant to act as a runner guide for corresponding support units 15.

Preferably at least a first roller/brush unit, and in particular each roller/brush unit has its axis at right angles to the direction of the slanting uprights 14.

Each mobile support unit 15 is associated with a carriage 25 pulled along a corresponding upright 14 of the frame 13 by a transmission organ 26, for example a jagged belt, attached to the carriage 25 and driven by a suitable motor 27.

The equipment 6 presents at least a first moving means 28 for moving at least the first roller and/or brushing means at right angles to the article 2 movement direction between an idle position and an operating position.

For each roller/brush unit, said moving means 28 are composed of a linear actuator 29 comprising, for example, a cylinder 32 integral with the mobile support unit 15 and a piston 33 that controls the carriage 30 run at right angles to article 2 travel direction in a guide 31, also integral with the mobile support unit 15.

Each carriage 30 supports a corresponding roller/brush unit mounted with a rotating roller, and a brush mounted in fixed position.

The brush can be easily removed in cases where brushing is to be performed at a different moment from the rolling operation.

Each carriage 30 is also mounted with a roller rotation control motor 34.

Naturally a transmission organ, preferably a jagged belt 35, is mounted between the roller and its driving motor 34. The overhead conveyor system 10 is provided with support organs 16 adapted to support the manufactured articles 2 revolving around an axis basically at right angles to its movement direction, and in this specific case, around a basically vertical axis.

The support organ 16 presents a first plate shaped positioning element 17 and at least a second element 18, respectively that can be engaged in a selective manner by the first or second guide means 20 and 21 to orient each manufactured article 2 during rolling and/or brushing operations in a first or at least second pre-established angular rotation position, preferably basically rotated at 90° in relation to the first pre-established angular position.

The plate shaped positioning elements 17 and 18 are positioned alongside each other with their surfaces lying flat basically at right angles to each other. The support organ 16 is oriented so that the plate-shaped positioning elements 17 and 18 are oriented one on top of the other.

The guide means 20 and 21 are also positioned one on top of the other so that each means corresponds with one or the other of the plate-shaped positioning elements 17 and 18.

The guide means 20 and 21 are moved by a corresponding linear actuator 23 at right angles to the article 2 movement direction, and are provided with a pair of plates 24 facing each other to form a guide runner channel that is only slightly wider than the thickness of the plate-shaped positioning elements 17 and 18.

Each linear actuator 23 comprises, for example, a cylinder 40 attached to the fixed support frame of the mobile support unit 15 and a piston 41 that activates the guide means 20 and 21. As it is known, each end of each roller axis is mounted with two fixed arms destined for two suction means (not shown) for example, suction vents, adapted to remove any paint eliminated during the roller treatment on the manufactured article 2.

The painting method, and with particular reference to the operations that are performed in at least one of the painting centres and in at least one of the brushing and/or roller centres, is apparent from the descriptions and illustrations above, and in particular, the method is composed as follows:

As it travels along the continuous passage in a painting centre, the manufactured article 2 is subject to a first measuring operation to calculate the size of a pair of opposite side faces, afterwards it is then rotated by goo with respect to the measurement means, and it is subject to a second measurement to calculate the size of the other pair of opposite side faces.

In the paint centre it is firstly performed the application of a paint layer on a pair of opposite side faces of the article according to the first detected measure and a dedicated formula to obtain the desired paint amount for the final required effect.

The article is then rotated by 90° and is painted at the other pair of its opposite side faces according to the second detected measure and a dedicated formula to obtain the desired paint amount for the final required effect.

Each spray gun in the forward following up section of its cyclic passage performs the painting, from top to bottom or vice versa on the article and in the return following up section of its cyclic passage performs the painting, from bottom to top or vice versa on the successive article (if present).

On the other hand, during the forward continuous passage through a roller and/or brushing equipment, an article, and then the successive article (if present) pass through the first set of two pairs of roller/brush units positioned opposite each other and are simultaneously subject to the rolling and/or brushing treatment in correspondence to the pair of opposite face surfaces each one carried out by a corresponding pair of roller/brush units opposite each other.

The two pairs of roller/brush units opposite each other carry out their function in the following up section of the corresponding cyclic passage from top to bottom and in the unloaded return passage, from bottom to top.

After the passage through the first series of roller/brush units the article(s) are rotated by 90° and are conveyed to the second set of two roller/brush units opposite each other to be subjected to a similar rolling and/or brushing treatment corresponding to the other pair of side faces.

During the rolling and/or brushing treatment each mobile support unit 15 moves along the corresponding sloped upright 14, while each carriage 30 moves the corresponding roller/brush unit as needed between the work position and idle position. Still during the brushing and/or rolling treatment through the first set of roller/brush units, the first mobile guides 20 slide to engage the first plate-shaped element 17 of support organ 16 so as to block the lying position of the article(s) with a pair of opposite side surfaces facing the second set of roller/brush units.

In similar manner, during the rolling and/or brushing treatment through the second set of roller/brush units the second mobile guide means 21 slides to engage the second plate-shaped element 17 of support organ 16 so as to block the lying position of the article(s) with the other pair of opposite side faces, facing the second set of roller/brush units.

During the relative movement between each roller/brush unit and the manufactured article, used to slide the roller/brush unit along the total face of the article to be treated, the roller can be activated to roll without or with a sliding action on the article face.

Rolling action without roller sliding on the article face acts so that the work surface of the coating layer adheres to the article face to be decorated, and so that the powder paint previously laid in a uniform manner on the surface to be decorated is picked up by the protruding peaks of the matrix on the roller coating layer leaving an impression that reproduces perfectly the original matrix pattern.

The rolling and sliding action by the roller on the article creates an impression on the face to be decorated that does not reproduce the exact pattern of the matrix, but creates a distorted effect that imitates wood grain and knots.

In particular, with the roller sliding action on the article, raised and recessed effects are obtained that confer the required tactile as well as visual aspect of wood.

This is obtained due to the fact that the roller shifts the last powder paint layer, modifying the thickness before final polymerisation.

Lastly, it should be noted that as more than one baking operations are envisaged to complete paint layer polymerisation, and in particular, a first baking treatment to fix the first base coat, a second baking to fix the second paint layer, that is a light coating, and a third and final baking to complete the polymerisation of the first layer, second layer and third layer of coating paint, the adhesion between the various layers of paint, and between the first layer and the article's metal surface, is improved considerably.

This occurs because the plurality of baking operations helps co-penetration between the various paint layers, and the penetration of the first paint layer into the porous metal surface of the article.

The third and most external paint layer can transpierce the second paint layer completely to penetrate deeply even into the first paint layer.

In particular, as an example, with a first paint layer having a theoretical thickness of 70 microns, and a second layer and a third layer, having a thickness of 5 microns, after the final baking the second and third paint layers will penetrate the first paint layer for a depth at least equal to 10 microns.

The painting method and application equipment thus obtained can be subject to numerous modifications and variants, all of which falling within the scope of the invention; moreover, all components can be replaced by technically equivalent elements.

1. Method for the application of powder paint on at least one manufactured article comprising the application of a first layer of powder paint, the fixing of said first paint layer, the application of at least a second layer of powder paint with a colour, tone and/or properties different from the first paint layer, the final baking of said first and at least a second paint layer, the rolling and/or brushing of the article to reproduce the required decoration, characterised in that said method is carried out by a continuous forward travel motion applied to said at least one manufactured article, and subjecting at least the first painting means during the painting step, and respectively at least the first rolling and/or brushing means during the rolling and/or brushing step, to move on a corresponding closed cyclic passage comprising at least a first following up section of said at least one manufactured article during which a relative movement is imposed between said first at least painting means and respectively said rolling and/or brushing means, and said at least one manufactured article.

2. Powder painting method according to the previous claim, characterised in that said at least first following up section develops along a sloped direction in relation to the movement direction of said at least one manufactured article.

3. Powder painting method according to one or more of the previous claims, characterised in that at least the application step of said at least one second paint layer is preceded by a measuring step to calculate the size of said at least one manufactured article in order to dose the amount of paint powder to be applied according to said measurement and a dedicated formula to obtain the final required effect.

4. Powder painting method according to one or more of the previous claims, characterised in that for the application of each paint layer, said at least first painting means carries out along said corresponding cyclic passage, a first following up section sloped in relation to the movement direction of said at least one manufactured article, adapted to apply the paint on said at least one manufactured article, a first return section parallel to the movement direction of said at least one manufactured article, a second following up section sloped in relation to the movement direction of said at least one manufactured article, adapted to the painting of one eventual second manufactured article, and a second return section parallel to said movement direction of said at least one manufactured article.

5. Powder painting method according to one or more of the previous claims, characterised in that for the rolling and/or brushing operations, said at least first rolling and/or brushing means carries out along said corresponding cyclic passage, a single following up section sloped in relation to the movement direction of said at least one manufactured article, adapted to carry out the rolling and/or brushing action on said at least one manufactured article and on an eventual successive article, and along a single return section in the opposite direction to said first following up section.

6. Powder painting method according to one or more of the previous claims, characterised in that it comprises a sequence comprising the application of the first base coat of paint, the fixing of said first base coat, the application of a second light coat layer of paint, the brushing to confer a uniform variegated aspect on said at least one manufactured article, the fixing of said second paint layer, the application of a third layer of coating paint, the rolling action to confer the required final decorative finish on said at least one manufactured article, followed by final oven baking.

7. Powder painting equipment for at least one manufactured article comprising a first centre for applying the first layer of powder paint, a first station for fixing said first paint layer, at least a second centre for applying at least a second layer of powder paint in a colour, tone and/or with properties different from said first paint layer, a second station for the final baking of said first and at least one second paint layer, an equipment for rolling and/or brushing the manufactured article to reproduce the desired decorative effect, characterised in that it comprises moving means to generate the continuous forward movement of said at least one said manufactured article, in that a first mobile support unit is mounted in each paint application centre adapted to move at least the first paint application means along a corresponding closed cyclic passage, including at least a first following up section of said at least one manufactured article during which a relative movement is imposed between said at least first paint application means and said at least one article, and in that a first mobile unit exists in said rolling and/or brushing equipment, adapted to move at least the first roller and/or brush means along a corresponding closed passage including at least a first following up section of said at least one manufactured article during which a relative movement is imposed between said at least first roller and/or brush means and said at least one manufactured article.

8. Powder painting equipment according to the previous claim, characterised in that in each paint application centre said cyclic passage comprises a first following up section sloped in relation to the movement direction of said at least one said manufactured article, a first return section parallel to the movement direction of said at least one manufactured article, a second following up section sloped in relation to the forward movement direction of said at least one article, and a second return section parallel to said movement direction of said at least one article.

9. Powder painting equipment according to one or more of the previous claims, characterised in that it comprises means for measuring the size of said at least one manufactured article at the entry of said at least a second centre for the application of at least a second paint layer, as well as control means that delivers a paint amount according to the detected measurements and to a dedicated formula to obtain the required final effect.

10. Powder painting equipment according to one or more of the previous claims, characterised in that in each painting centre said at least first support unit for said at least first paint application means moves on a fixed guide comprising a first and second portion of guide sloped in relation to the forward movement direction of said at least one manufactured article, and a third and fourth portion parallel to the movement direction of said at least one manufactured article.

11. Powder painting equipment according to one or more of the previous claims, characterised in that in each painting centre said at least a first mobile support unit for said at least first paint application means moves on a mobile guide positioned at right angles to the forward movement direction of said at least one manufactured article and carried in turn by a mobile support unit in a direction parallel to the movement direction of said at least one manufactured article.

12. Equipment in a powder paint application equipment for rolling and/or brushing at least one manufactured article to reproduce the desired decorative finish, characterised in that it includes at least a first rolling and/or brushing means mounted on a first mobile support unit adapted to move it along a corresponding closed circuit passage comprising of a single following up section of said at least one manufactured article during which the movement is imposed between said first roller and/or brush means and said at least one manufactured article, and a single return section, said following up section being developed in a direction that slopes in relation to the movement direction of said at least one manufactured article.

13. Equipment for rolling and/or brushing according to the previous claim, characterised in that it comprises at least a second rolling and/or brushing means for simultaneous rolling and brushing of said at least one manufactured article and a successive article.

14. Equipment for rolling and/or brushing according to one or more previous claims, comprising an overhead conveyor system for said at least one manufactured article, presenting at least one support organ adapted to support and revolve said at least one manufactured article around an axis substantially at right angles to the movement direction of said at least one manufactured article, and characterised in that said support organ presents a first plate-shaped positioning element engaged to slide along the corresponding first guide means adapted to block said at least one manufactured article in a first pre-established angular position in relation to the relative rotating axis during rolling and/or brushing operations, and at least one second plate-shaped positioning element engaged to slide along the corresponding at least second guide means adapted to block said at least one manufactured article in a second pre-established angular position in relation to the relative rotating axis during rolling and/or brushing operations.

15. Equipment for rolling and/or brushing according to one or more previous claims, characterised in that said first and at least second plate shaped elements have a lying plane substantially at right angles to each other to block said at least one manufactured article in a first pre-established angular position or in a second pre-established angular position substantially rotated by 90° in relation to the first established angular position during rolling and/or brushing operations.

16. Equipment for rolling and/or brushing according to one or more previous claims, characterised in that said at least first and second rolling and/or brushing means presents an axis at right angles to said sloping direction of said following up section.

17. Equipment for rolling and/or brushing according to one or more previous claims, characterised in that said guide means of said first and second positioning elements is propelled by a corresponding linear actuator at right angles to the movement direction of said at least one manufactured article.

18. Equipment for rolling and/or brushing according to one or more previous claims, characterised in that said at least first mobile support unit of said at least first rolling and/or brushing means comprises a carriage moved along a corresponding sloping upright of the equipment frame driven by a motor through a transmission organ.

19. Equipment for rolling and/or brushing according to one or more previous claims, characterised in that it includes at least a first moving means mounted on said at least first mobile support unit of said at least first rolling and/or brushing equipment set at right angles to the movement direction of the said at least one manufactured article, between the idle position and operating position.

20. Equipment for rolling and/or brushing according to one or more previous claims, characterised in that said at least first moving means comprises an actuator for the linear control of a carriage sliding on a guide at right angles to the movement direction of said at least one manufactured article, said a carriage supporting said at least first rolling and/or brushing means and a rotation control motor for said at least first rolling means.

21. Equipment for rolling and/or brushing according to one or more previous claims, characterised in that it foresees the application of a coating layer in deformable elastic material to the side surface of the rollers, presenting a working face composed of a series of peaks and hollows specifically processed thereon according to the graphic effect one intends obtaining on the manufactured article

22. Equipment for rolling and/or brushing according to one or more previous claims, characterised in that said rollers are directed to roll with or without a sliding action on the manufactured article according to the graphic effect one intends obtaining.

23. Manufactured article having a coating obtained through the application of powder paint, characterised in that it comprises a first layer of base coat that penetrates the porous surface of the manufactured article, a second light paint layer that penetrates the first paint layer at least partially, and a third paint layer that penetrates at least the second paint layer, said coating having a variable thickness obtained through a rolling action accompanied by a rolling and sliding action applied to the third paint layer before polymerisation to confer the desired tactile and visual effect on the manufactured article.

24. Decorative method used on at least one manufactured article through the application of powder paint and the relative equipment as described and illustrated.
